(19) United States
(12) Patent Application Publication
(10) Pub. No.: US 2026/0127180 A1
(43) Pub. Date: May 7, 2026

(54) DATA PROCESSING METHOD AND APPARATUS, ELECTRONIC DEVICE, AND STORAGE MEDIUM

(71) Applicant: BEIJING OCEANBASE TECHNOLOGY CO., LTD., Hangzhou (CN)

(72) Inventors: Ju REN, Hangzhou (CN); Zhenjiang Xie, Hangzhou (CN); Yuzhong Zhao, Hangzhou (CN)

(21) Appl. No.: 19/427,866

(22) Filed: Dec. 19, 2025

Related U.S. Application Data
(63) Continuation of application No. PCT/CN2024/128079, filed on Oct. 29, 2024.

(30) Foreign Application Priority Data
Dec. 13, 2023 (CN) 202311716552.8

(51) Int. Cl. G06F 16/2455; G06F 16/22

(52) U.S. Cl. CPC G06F 16/24561; G06F 16/221

(57) ABSTRACT

One or more implementations of the present specification provide a data processing method and apparatus, an electronic device, and a storage medium. The method includes: in a process of writing target data in a memory into a disk, in response to receiving a query instruction for the target data, separately querying data from at least one piece of first local data and at least one piece of second local data based on the query instruction, intermediate index layer information of the at least one piece of first local data, and intermediate index layer information of the at least one piece of second local data, and sorting the queried data as a data query result. The first local data includes some data stored in the disk in the target data, the second local data includes some data stored in the memory in the target data, the target data is in a column-stored form, and each column group of the target data corresponds to one piece of second local data.

### TECHNICAL FIELD

One or more implementations of the present specification relate to the field of database technologies, and in particular, to a data processing method and apparatus, an electronic device, and a storage medium.

### BACKGROUND

With today's rapid development of the Internet and informatization, data generation is explosively increasing. Therefore, requirements on databases and database management are increasingly high. During data processing, data manipulation languages (DML) need to be used to operate data tables, for example, add, delete, query, or modify data. During data processing, data definition languages (DDL) are further used to reorganize data, for example, create a new table, delete a column, or change a column type.

In the related technologies, in a process of reorganizing data by using a DDL, related data cannot provide a query service externally, which affects service processing of databases, causing service problems such as service request timeout.

### SUMMARY

According to a first aspect of one or more implementations of the present specification, a data processing method is provided. The method includes: in a process of writing target data in a memory into a disk, in response to receiving a query instruction for the target data, separately querying data from at least one piece of first local data and at least one piece of second local data based on the query instruction, intermediate index layer information of the at least one piece of first local data, and intermediate index layer information of the at least one piece of second local data, and sorting the queried data as a data query result. The first local data includes some data stored in the disk in the target data, the second local data includes some data stored in the memory in the target data, the target data is in a column-stored form, and each column group of the target data corresponds to one piece of second local data.

In an implementation of the present specification, the query instruction includes a query range and a query condition; and the separately querying the data from the at least one piece of first local data and the at least one piece of second local data based on the query instruction, the intermediate index layer information of the at least one piece of first local data, and the intermediate index layer information of the at least one piece of second local data, and sorting the queried data as the data query result includes: separately querying data within the query range from the at least one piece of first local data and the at least one piece of second local data based on the intermediate index layer information of the at least one piece of first local data and the intermediate index layer information of the at least one piece of second local data, and sorting the queried data as to-be-queried data; and querying the to-be-queried data based on the query condition, to determine the data query result.

In an implementation of the present specification, the query range includes a column query range of at least one column group; and the separately querying the data within the query range from the at least one piece of first local data and the at least one piece of second local data based on the query range, the intermediate index layer information of the at least one piece of first local data, and the intermediate index layer information of the at least one piece of second local data, and sorting the queried data as the to-be-queried data includes: for a column group to which each column query range in the query range belongs, determining, based on intermediate index layer information of first local data and intermediate index layer information of second local data in the column group and the column query range of the column group, a first row offset range corresponding to the column query range of the column group; determining a second row offset range based on the first row offset range corresponding to each column query range in the query range; and separately querying data within the second row offset range from the at least one piece of first local data and the at least one piece of second local data based on the second row offset range, the intermediate index layer information of the at least one piece of first local data, and the intermediate index layer information of the at least one piece of second local data, and sorting the queried data as the to-be-queried data.

In an implementation of the present specification, the determining, based on the intermediate index layer information of the first local data and the intermediate index layer information of the second local data in the column group and the column query range of the column group, the first row offset range corresponding to the column query range of the column group includes: separately querying data within a third row offset range within the query range from the first local data and the second local data in the column group based on the intermediate index layer information of the first local data and the intermediate index layer information of the second local data in the column group, and sorting the queried data by row offset as a column query result of the column group; and filtering the column query result of the column group based on the column query range of the column group, to obtain the first row offset range corresponding to the column query range of the column group.

In an implementation of the present specification, the query range includes a primary key range; and the method further includes: separately querying data within the primary key range from first local data and second local data in a primary key column based on intermediate index layer information of the first local data and intermediate index layer information of the second local data in the primary key column, and sorting the queried data by row offset as a primary key query result; and determining a second row offset range within the query range based on a row offset of data in the primary key query result.

In an implementation of the present specification, data in the first local data and the second local data is stored in a form of a data block, and each data block stores some data; and the separately querying the data within the query range from the at least one piece of first local data and the at least one piece of second local data based on the intermediate index layer information of the at least one piece of first local data and the intermediate index layer information of the at least one piece of second local data, and sorting the queried data as the to-be-queried data includes: separately querying a data block to which the data within the query range belongs from the at least one piece of first local data and the at least one piece of second local data based on the intermediate index layer information of the at least one piece of first local data and the intermediate index layer information of the at least one piece of second local data, and sorting the queried data block as to-be-queried data.

In an implementation of the present specification, the data block includes a macro block and a micro block.

In an implementation of the present specification, the target data includes: data generated in the memory based on a data definition language (DDL).

In an implementation of the present specification, different column groups of the target data correspond to same first local data; or different column groups of the target data correspond to different first local data.

According to a second aspect of one or more implementations of the present specification, a data processing apparatus is provided. The apparatus includes: a real-time query module, configured to: in a process of writing target data in a memory into a disk, in response to receiving a query instruction for the target data, separately query data from at least one piece of first local data and at least one piece of second local data based on the query instruction, intermediate index layer information of the at least one piece of first local data, and intermediate index layer information of the at least one piece of second local data, and sort the queried data as a data query result. The first local data includes some data stored in the disk in the target data, the second local data includes some data stored in the memory in the target data, the target data is in a column-stored form, and each column group of the target data corresponds to one piece of second local data.

In an implementation of the present specification, the query instruction includes a query range and a query condition; and the real-time query module is configured to: separately query data within the query range from the at least one piece of first local data and the at least one piece of second local data based on the intermediate index layer information of the at least one piece of first local data and the intermediate index layer information of the at least one piece of second local data, and sort the queried data as to-be-queried data; and querying the to-be-queried data based on the query condition, to determine the data query result.

In an implementation of the present specification, the query range includes a column query range of at least one column group; and when separately querying the data within the query range from the at least one piece of first local data and the at least one piece of second local data based on the query range, the intermediate index layer information of the at least one piece of first local data, and the intermediate index layer information of the at least one piece of second local data, and sorting the queried data as the to-be-queried data, the real-time query module is configured to: for a column group to which each column query range in the query range belongs, determine, based on intermediate index layer information of first local data and intermediate index layer information of second local data in the column group and the column query range of the column group, a first row offset range corresponding to the column query range of the column group; determine a second row offset range based on the first row offset range corresponding to each column query range in the query range; and separately query data within the second row offset range from the at least one piece of first local data and the at least one piece of second local data based on the second row offset range, the intermediate index layer information of the at least one piece of first local data, and the intermediate index layer information of the at least one piece of second local data, and sort the queried data as the to-be-queried data.

In an implementation of the present specification, when determining, based on the intermediate index layer information of the first local data and the intermediate index layer information of the second local data in the column group and the column query range of the column group, the first row offset range corresponding to the column query range of the column group, the real-time query module is configured to: separately query data within a third row offset range within the query range from the first local data and the second local data in the column group based on the intermediate index layer information of the first local data and the intermediate index layer information of the second local data in the column group, and sort the queried data by row offset as a column query result of the column group; and filter the column query result of the column group based on the column query range of the column group, to obtain the first row offset range corresponding to the column query range of the column group.

In an implementation of the present specification, the query range includes a primary key range; and the apparatus further includes a primary key module, configured to: separately query data within the primary key range from first local data and second local data in a primary key column based on intermediate index layer information of the first local data and intermediate index layer information of the second local data in the primary key column, and sort the queried data by row offset as a primary key query result; and determine a second row offset range within the query range based on a row offset of data in the primary key query result.

In an implementation of the present specification, data in the first local data and the second local data is stored in a form of a data block, and each data block stores some data; and when separately querying the data within the query range from the at least one piece of first local data and the at least one piece of second local data based on the intermediate index layer information of the at least one piece of first local data and the intermediate index layer information of the at least one piece of second local data, and sorting the queried data as the to-be-queried data, the real-time query module is configured to: separately query a data block to which the data within the query range belongs from the at least one piece of first local data and the at least one piece of second local data based on the intermediate index layer information of the at least one piece of first local data and the intermediate index layer information of the at least one piece of second local data, and sort the queried data block as to-be-queried data.

In an implementation of the present specification, the data block includes a macro block and a micro block.

In an implementation of the present specification, the target data includes: data generated in the memory based on a data definition language (DDL).

In an implementation of the present specification, different column groups of the target data correspond to same first local data; or different column groups of the target data correspond to different first local data.

According to a third aspect of one or more implementations of the present specification, an electronic device is provided, including: a processor; and a storage, configured to store processor-executable instructions. The processor runs the executable instructions to implement the method according to the first aspect.

According to a fourth aspect of one or more implementations of the present specification, a computer-readable storage medium is provided. The computer-readable storage medium stores computer instructions, and when the instructions are executed by a processor, the steps of the method according to the first aspect are implemented.

The technical solutions provided in the implementations of the present specification can include the following beneficial effects:

According to the data processing method provided in the implementations of the present specification, in a process of writing target data in a memory into a disk, in response to receiving a query instruction for the target data, data can be separately queried from at least one piece of first local data and at least one piece of second local data based on the query instruction, intermediate index layer information of the at least one piece of first local data, and intermediate index layer information of the at least one piece of second local data, and the queried data can be sorted as a data query result. The first local data includes some data stored in the disk in the target data, the second local data includes some data stored in the memory in the target data, the target data is in a column-stored form, and each column group of the target data corresponds to one piece of second local data. In other words, in the method, a query service can be provided externally in real time in a process in which column-stored data is written into the disk from the memory. Each column group of the column-stored data is stored in the memory as independent second local data. Therefore, in the method, after data query is performed on a plurality of pieces of local data in the disk and the memory, the queried data is sorted, thereby ensuring accuracy of a data query result. Further, in the method, a query service for related data can be provided in a process of defining a data table by using a DDL, to ensure a service processing response speed of a database and avoid a problem such as service request timeout.

### BRIEF DESCRIPTION OF DRAWINGS

FIG. 1 is a flowchart illustrating a data processing method according to an example implementation;

FIG. 2 is a schematic diagram illustrating intermediate index layer information according to an example implementation;

FIG. 3 is a flowchart illustrating a data processing method according to an example implementation;

FIG. 4 is a schematic diagram illustrating a multiway merge query manner according to an example implementation;

FIG. 5 is a schematic diagram illustrating intermediate index layer information of first local data and second local data in column group C2 according to an example implementation;

FIG. 6 is a schematic diagram illustrating intermediate index layer information of first local data and second local data in column group C3 according to an example implementation;

FIG. 7 is a schematic structural diagram illustrating a device according to an example implementation; and

FIG. 8 is a block diagram illustrating a data processing apparatus according to another example implementation.

### DESCRIPTION OF IMPLEMENTATIONS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with one or more implementations of the present specification. On the contrary, the implementations are merely examples of apparatuses and methods consistent with some aspects of one or more implementations of the present specification described in detail in the appended claims.

It should be noted that, in other implementations, the steps of the corresponding method are not necessarily performed in the sequence shown and described in the present specification. In some other implementations, the method can include more or fewer steps than those described in the present specification. In addition, a single step described in the present specification may be broken down into a plurality of steps in other implementations for description, and a plurality of steps described in the present specification may be combined into a single step in other implementations for description.

With today's rapid development of the Internet and informatization, data generation is explosively increasing. Therefore, requirements on databases and database management are increasingly high. During data processing, data manipulation languages (DML) need to be used to operate data, for example, add, delete, query, or modify data. During data processing, data definition languages (DDL) are further used to reorganize data, for example, create a new table, delete a column, or change a column type.

In the related technologies, in a process of reorganizing data by using a DDL, related data cannot provide a query service externally, which affects service processing of databases, causing service problems such as service request timeout. For example, when some operations (for example, deleting a column or changing a column type) of data reorganization are performed by using the DDL, a read/write service can be provided externally only after reorganized data is written into a hidden table in a memory, is flushed to a disk, and takes effect (e.g., dumped into a disk). When a data volume is relatively large, the above process consumes a relatively long time. Consequently, the reorganized data cannot provide a read/write service externally within a certain period of time. In particular, when the DDL is used to reorganize column-stored data, because the column-stored reorganized data may exist in a plurality of column groups, and each column group is independently subjected to the above process (e.g., data in each column group is written into a different hidden table, and is independently flushed to a disk. For example, a synchronous flush-to-disk progress cannot be ensured), a degree of dispersion of the reorganized data in the above process is higher, and it is more difficult to provide a read/write service externally.

At least one implementation of the present specification provides a data processing method. In the method, a read/write service such as a query service can be provided in real time in a process in which data in a memory is dumped into a disk (e.g., a flush-to-disk process). For example, certain data, particularly column-stored data that includes a plurality of column groups, is dispersed in the memory and the disk in the flush-to-disk process. In the method, a read/write service can be provided in real time for the data that is in a dispersed state in the flush-to-disk process, particularly the column-stored data that includes the plurality of column groups.

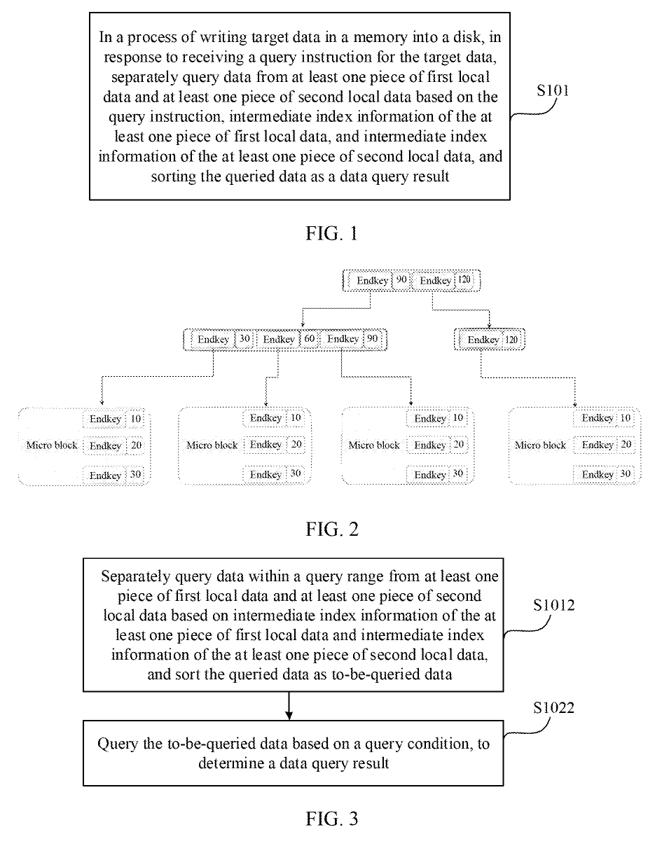

Referring to FIG. 1, an example procedure of the data processing method is shown, including step S101.

In step S101, in a process of writing target data in a memory into a disk, in response to receiving a query instruction for the target data, data is separately queried from at least one piece of first local data and at least one piece of second local data based on the query instruction, intermediate index layer information of the at least one piece of first local data, and intermediate index layer information of the at least one piece of second local data, and the queried data is sorted as a data query result.

For example, the target data can include (reorganized) data generated in the memory based on a data definition language (DDL). For example, the target data can be reorganized data formed by performing an operation such as creating a new table, deleting a column, or changing a column type based on the DDL. The reorganized data obtained based on the DDL needs to be first written into the memory, and then written into the disk from the memory (e.g., flushed to the disk). This step occurs in a process in which the reorganized data is flushed to the disk.

For example, the target data can be in a column-stored form or row-stored form. The row-stored form means that a row is used as a basic unit during data storage, and each row includes values of all fields in a table. The column-stored form means that a column is used as a basic unit during data storage, and data in the same column is stored together, to facilitate data aggregation and data compression. Because column-stored reorganized data may exist in a plurality of column groups, a degree of dispersion of the column-stored reorganized data in a flush-to-disk process is higher (a related reason has been described in detail above, and details are omitted herein for simplicity). Therefore, in the following content of the method, the column-stored data is illustratively used as an example to describe the procedure of the method, to increase an adaptation scope of the method. However, this is not a limitation on the form of the target data used in the method.

The first local data includes some data (for example, referred to as SSTable) of the target data stored in the disk.

The second local data includes some data (for example, referred to as DDLKV) of the target data stored in the memory.

It should be understood that if the target data is in the column-stored form, the target data includes a plurality of column groups (the column group is an ancestral form that includes one or more columns of data in column storage). For example, when the target data is generated in the memory, second local data DDLKV including a plurality of column groups can be generated. For example, each column group corresponds to one piece of second local data DDLKV. Further, in the process of writing the target data in the memory into the disk, the target data is dispersed in at least one piece of first local data and at least one column group of second local data. The number of first local data is determined by a form of a part of data in each column group that is written into the disk. For example, if the part of data in each column group that is written into the disk is stored in one piece of first local data SSTable, the number of first local data is 1. Different column groups of the target data correspond to the same first local data SSTable. For another example, if the part of data in each column group that is written into the disk is separately stored in different first local data SSTable, the number of first local data is the same as that of column groups. Different column groups of the target data correspond to different first local data. For example, the part of data in each column group that is written into the disk is stored in one piece of first local data SSTable.

The number of second local data DDLKV is determined by flush-to-disk progress of data in each column group. For example, if all data in a certain column group is flushed to the disk, second local data DDLKV of the column group does not exist in the memory. For another example, if not all data in a certain column group is flushed to the disk, second local data DDLKV of the column group exists in the memory.

Second local data SSTable persisted on the disk includes metadata information of the second local data SSTable and a series of data macro blocks, and each data macro block can be further divided into a plurality of micro blocks. The data macro block includes a plurality of rows of sorted data, is persisted on the disk, has a fixed size of 2M, and is a basic constituent unit of SSTable. The micro block is a basic constituent unit of the data macro block, includes a plurality of rows of sorted data, is persisted on the disk, has an unfixed size that is usually several KB, and is a minimum unit for reading SSTable data from the disk. First local data stored in the memory can be alternatively stored in the memory in a manner of second local data. For example, the first local data includes metadata of the first local data and a series of data macro blocks, and each data macro block can be further divided into a plurality of micro blocks. Macro blocks and micro blocks in the first local data and the second local data can be organized by using intermediate index layer information to accelerate query. The intermediate index layer information of the first local data and the second local data can represent an internal data organization form, e.g., represent distribution information of the first local data on different macro blocks and micro blocks inside the first local data. FIG. 2 shows, as an illustrative example, intermediate index layer information of certain first local data. It can be learned from the figure that the intermediate index layer information is of a tree structure, and includes at least one layer of index information and a bottom-layer macro block. There is a micro block in the macro block. The index information is divided layer by layer. For example, each layer of index information includes a plurality of pieces of sub-local data obtained by dividing the first local data, and the number of pieces of sub-local data included in index information at a lower layer is greater than the number of pieces of sub-local data included in index information at an upper layer. Certain sub-local data in the index information at the upper layer is divided into at least one piece of sub-local data in the index information at the lower layer, and each piece of sub-local data in index information at a lowermost layer corresponds to one data macro block. The sub-local data can be represented by a key value range and a row offset range. For example, the sub-local data in FIG. 2 is represented by an end value (endkey) of the key value range and an end value of the row offset range, and a row offset in the sub-local data is an absolute offset of the data in the first local data. The macro block includes a plurality of micro blocks. The micro block can be represented by a key value range and a row offset range. For example, the micro block in FIG. 2 is represented by an end value of the key value range and an end value of the row offset range. However, a row offset in the micro block is a relative offset of the micro block in the macro block.

The query instruction can include a query range and a query condition. For example, the step can be performed in the manner shown in FIG. 3, and includes sub-step S1011 and sub-step S1012.

In sub-step S1011, data within the query range is separately queried from the at least one piece of first local data and the at least one piece of second local data based on the intermediate index layer information of the at least one piece of first local data and the intermediate index layer information of the at least one piece of second local data, and the queried data is sorted as to-be-queried data.

The query range can include a column query range of at least one column group. In some implementations, the query range can be represented by the column query range of the at least one column group, for example, a value range of a certain column in the column group. This sub-step can be performed in the following manner: First, for a column group to which each column query range in the query range belongs, a first row offset range corresponding to the column query range of the column group is determined based on intermediate index layer information of first local data and intermediate index layer information of second local data in the column group and the column query range of the column group.

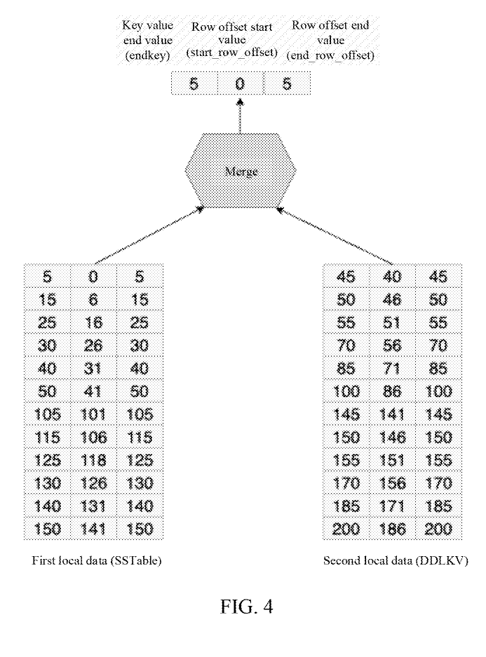

In some implementations, for first local data SSTable and second local data DDLKV that are related to the column group, an intermediate layer index iterator can be simulated by using intermediate index layer information, to separately perform data query, sort queried data by row offset as a column query result of the column group, and then filter the obtained column query result based on the column query range of the column group, to obtain the first row offset range corresponding to the column query range of the column group. Referring to FIG. 4, when data query is separately performed on the first local data SSTable and the second local data DDLKV that are related to the column group, a multiway merge manner can be used, to complete data query and data sorting at the same time. For example, when a certain macro block is queried from the first local data SSTable or the second local data DDLKV, if a row offset of the macro block shows that the macro block is a macro block with the smallest row offset in remaining data that needs to be queried, the macro block is output and added to a query result. The macro block is not output first, until the macro block is the macro block with the smallest row offset in the remaining data that needs to be queried, and then the macro block is output and added to the output result.

For example, the column query result of the column group can be determined in the following manner: All data in the column group is separately queried from the first local data and the second local data in the column group based on the intermediate index layer information of the first local data and the intermediate index layer information of the second local data in the column group, and the queried data is sorted by row offset as the column query result of the column group. For another example, the column query result of the column group can be determined in the following manner: Data within a second row offset range within the query range is separately queried from the first local data and the second local data in the column group based on the intermediate index layer information of the first local data and the intermediate index layer information of the second local data in the column group, and the queried data is sorted by row offset as the column query result of the column group. The second row offset range in the example can be a row offset range included in the query range, or an offset range determined based on a primary key range included in the query range in the following manner: First, data within the primary key range is separately queried from first local data and second local data in a primary key column (e.g., a column in which a primary key is located) based on intermediate index layer information of the first local data and intermediate index layer information of the second local data in the primary key column, and the queried data is sorted by row offset as a primary key query result; and a second row offset range within the query range is determined based on a row offset of data in the primary key query result (e.g., a union set of offsets of all rows of data in the primary key query result is determined as the second row offset range).

For example, the first row offset range corresponding to the column query range of the column group can be determined in the following manner: A union set of offsets of all rows of data that satisfy the column query range (the range is represented by a value in a column in the column group) in the column query range is determined as the first row offset range.

Next, the second row offset range is determined based on the first row offset range corresponding to each column query range in the query range. For example, based on a relationship between all column query ranges within the query range, an intersection set or a union set of first row offset ranges corresponding to all the column query ranges is taken to obtain the second row offset range. If the query range includes three column query ranges, and a relationship between the three column query ranges is an AND relationship, an intersection set of first row offset ranges corresponding to the three column query ranges can be determined as the second row offset range. If the query range includes three column query ranges, and a relationship between the three column query ranges is an OR relationship, a union set of first row offset ranges corresponding to the three column query ranges can be determined as the second row offset range.

Finally, data within the second row offset range is separately queried from the at least one piece of first local data and the at least one piece of second local data based on the second row offset range, the intermediate index layer information of the at least one piece of first local data, and the intermediate index layer information of the at least one piece of second local data, and the queried data is sorted as to-be-queried data. In other words, cross-local-data query of multiway merge is performed on at least one piece of first local data SSTable and at least one piece of second local data DDLKV in the target data by using the second row offset range, to implement simultaneous query and sorting, and finally output to-be-queried data sorted by row offset.

It should be understood that data in the first local data and the second local data is stored in a form of a data block. The data block includes a macro block and a micro block. Details of the macro block and the micro block have been described in detail above. Details are omitted herein for simplicity. Based on this, in this sub-step, a data block to which the data within the query range belongs can be separately queried from the at least one piece of first local data and the at least one piece of second local data based on the intermediate index layer information of the at least one piece of first local data and the intermediate index layer information of the at least one piece of second local data, and the queried data block can be sorted as to-be-queried data. In other words, at least one macro block sorted by row offset is obtained from the at least one piece of first local data and the at least one piece of second local data as the to-be-queried data.

In sub-step S1012, the to-be-queried data is queried based on the query condition, to determine the data query result.

The query condition can be a query condition for at least one column. If the query condition is null, the to-be-queried data can be directly determined as the data query result.

With reference to an illustrative example, the following describes in detail a data processing method obtained with reference to the above plurality of implementations.

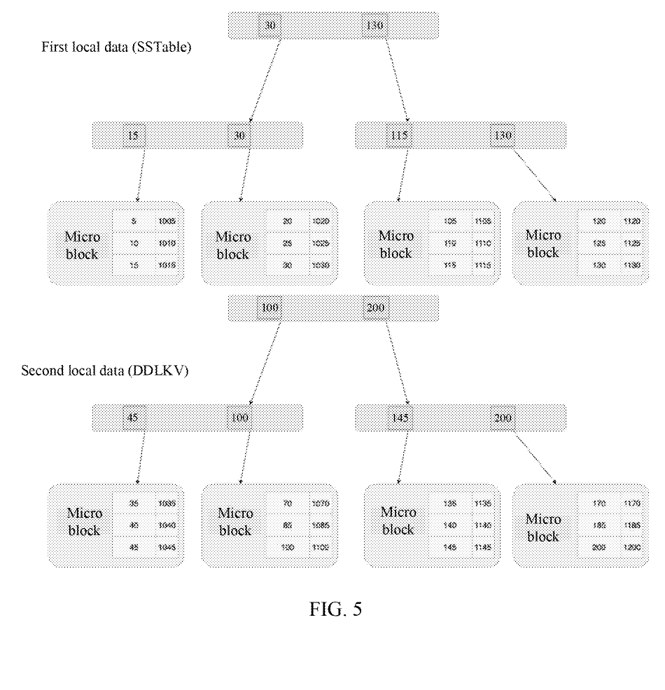

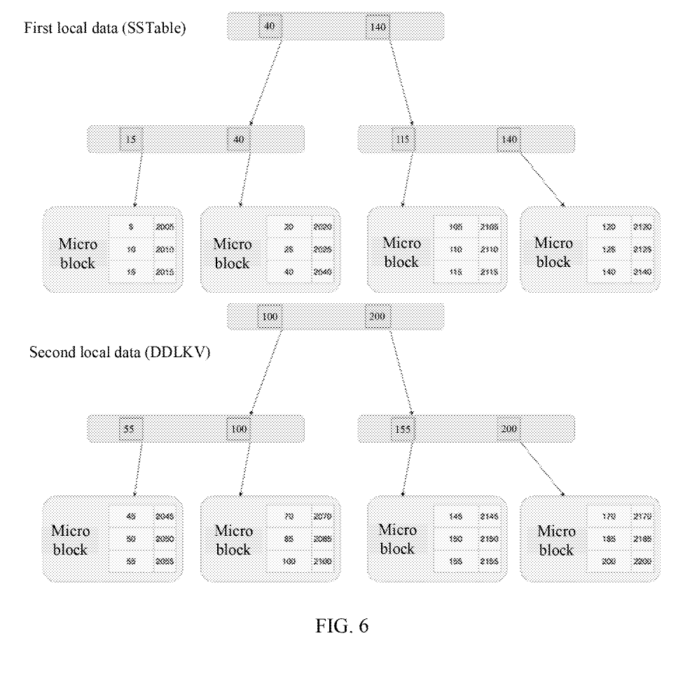

It is assumed that there is a table t1 (c1 int primary key, c2 int, c3 int), and there are two column groups in the table, which are respectively cg_c2(c2) and cg_c3(c3). There are 200 rows of data in the table, where data of c1 is (1…200), data of c2 is (1001...1200), and data of c3 is (2001…2200). During DDL execution, a parallelism is 2. For a row-stored column group, the first thread is responsible for data whose primary key is (1...100), and the second thread is responsible for data whose primary key is (101...200). At a certain moment in a process of writing the table from a memory into a disk, for Column Group cg_c2, when the first thread executes 1030 of c2, and the second thread executes 1130, the 1^{st} first local data SSTable1 is generated in a dump manner, and the remaining data is stored in second local data DDLKV1. For a layout of SSTable1 and DDLKV1, reference can be made to FIG. 5 (because key values and row offsets of all rows in t1 are the same, index information in the figure includes only the row offsets). For Column Group cg_c3, when the first thread executes 2040 of c3, and the second thread executes 2140, the 1^{st} first local data SSTable2 is generated in a dump manner, and the remaining data is stored in second local data DDLKV2. For a layout of SSTable2 and DDLKV2, reference can be made to FIG. 6 (because key values and row offsets of all rows in t1 are the same, index information in the figure includes only the row offsets).

In this case, if a query instruction select * from t1 where c2 > 1035 and c3 < 2120 and c1 >= 0 and c1 <150 for table t1 is received, the query can be completed across SSTable1, DDLKV1, SSTable2 and DDLKV2.

First, [25, 0, 25], [50, 26, 50], [75, 51, 75], [100, 76, 100], [125, 101, 125], and [150, 126, 150] (note: content in the above parentheses is respectively a key value end value, a row offset start value, and a row offset end value) can be sequentially iterated out by using an intermediate layer index iterator based on a primary key range [0, 150) in the query instruction, and intermediate index layer information of SSTable1 and intermediate index layer information of DDLKV1 that are shown in FIG. 5, or intermediate index layer information of SSTable2 and intermediate index layer information of DDLKV2 that are shown in FIG. 6. Therefore, a second row offset range row_offset in the query instruction can be obtained: start_row_offset is 0, and end_row_offset is 150.

Next, Column Group C2 and Column Group C3 are separately queried based on the second row offset range row_offset. For query of Column Group C2, [0, 15], [16, 30], [31, 45], [46, 100], [101, 115], [116, 130], [131, 145], and [146, 150] (note: content in the above parentheses is respectively a row offset start value and a row offset end value) are sequentially iterated out by using an intermediate layer index iterator based on the second row offset range row_offset, and the intermediate index layer information of SSTable1 and the intermediate index layer information of DDLKV1 that are shown in FIG. 5. In the above iteration process, apply_filter can be performed based on a certain batch size. Because a column query range of Column Group C2 is >1035, in a result map generated for Column Group C2, the preceding [0, 35] is 0, the posterior [36, 150] is 1, and a column query result of Column Group C2 is [36, 150]. For query of Column Group C3, [0, 15], [16, 40], [41, 55], [56, 100], [101, 115], [116, 140], and [141, 150] (note: content in the above parentheses is respectively a row offset start value and a row offset end value) are sequentially iterated out by using an intermediate layer index iterator based on the second row offset range row_offset, and the intermediate index layer information of SSTable2 and the intermediate index layer information of DDLKV2 that are shown in FIG. 6. In the above iteration process, apply_filter can be performed based on a certain batch size. Because a column query range of Column Group C3 is <2020, in a result map generated for Column Group C3, the preceding [0, 119] is 1, and the posterior [120, 150] is 0, e.g., a column query result of Column Group C3 is [0, 119].

Next, because a relationship between the column query ranges of C2 and C3 is and, an intersection set of the column query range [36, 150] of Column Group C2 and the column query result [0, 119] of Column Group C3 is taken to obtain a first row offset range [36, 119].

Finally, intermediate layer index rows are separately iterated in Column Group C2 and Column Group C3 based on the first row offset range [36, 119], to determine a micro block related to to-be-queried data. Then, whether a certain row of the micro block needs to be projected to a data query result is determined based on the micro block related to the to-be-queried data and a query condition result bitmap.

According to the data processing method provided in the implementations of the present specification, in a process of writing target data in a memory into a disk, in response to receiving a query instruction for the target data, data can be separately queried from at least one piece of first local data and at least one piece of second local data based on the query instruction, intermediate index layer information of the at least one piece of first local data, and intermediate index layer information of the at least one piece of second local data, and the queried data can be sorted as a data query result. The first local data includes some data stored in the disk in the target data, the second local data includes some data stored in the memory in the target data, the target data is in a column-stored form, and each column group of the target data corresponds to one piece of second local data. In other words, in the method, a query service can be provided externally in real time in a process in which column-stored data is written into the disk from the memory. Each column group of the column-stored data is stored in the memory as independent second local data. Therefore, in the method, after data query is performed on a plurality of pieces of local data in the disk and the memory, the queried data is sorted, thereby ensuring accuracy of a data query result. Further, in the method, a query service for related data can be provided in a process of defining a data table by using a DDL, to ensure a service processing response speed of a database and avoid a problem such as service request timeout.

According to the data processing method provided in the implementations of the present specification, in a process in which reorganized data in a column-stored form is written into the disk from the memory, SSTable and DDLKV corresponding to different column groups have different progress. To prevent playback from being stuck and provide an external query service as soon as possible, a fusion query solution can be provided based on intermediate layer index information, and queried data is fused and merged by using an intermediate layer index iterator, to accurately and efficiently iterate out needed data.

FIG. 7 is a schematic structural diagram illustrating a device according to an example implementation. Referring to FIG. 7, in terms of hardware, the device includes a processor 702, an internal bus 704, a network interface 706, a memory 708, and a non-volatile storage 710, and certainly can further include hardware needed for another task. One or more implementations of the present specification can be implemented in a software-based manner. For example, the processor 702 reads a corresponding computer program from the non-volatile storage 710 into the memory 708, and then runs the computer program. Certainly, in addition to a software implementation, one or more implementations of the present specification do not exclude another implementation, for example, a logic device or a combination of hardware and software. For example, an execution body of the following processing procedure is not limited to each logical unit, and can be hardware or a logic device.

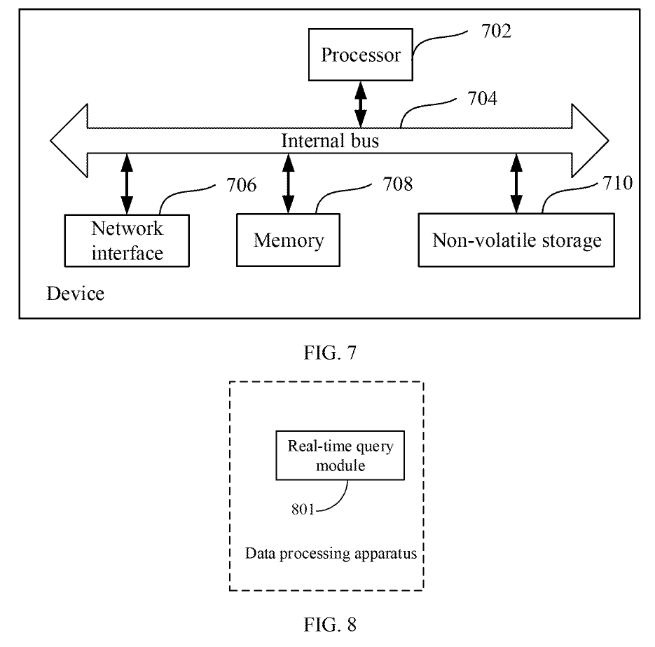

Referring to FIG. 8, a data processing apparatus can be used in the device shown in FIG. 7, to implement the technical solutions of the present specification. The apparatus includes: a real-time query module 801, configured to: in a process of writing target data in a memory into a disk, in response to receiving a query instruction for the target data, separately query data from at least one piece of first local data and at least one piece of second local data based on the query instruction, intermediate index layer information of the at least one piece of first local data, and intermediate index layer information of the at least one piece of second local data, and sort the queried data as a data query result. The first local data includes some data stored in the disk in the target data, the second local data includes some data stored in the memory in the target data, the target data is in a column-stored form, and each column group of the target data corresponds to one piece of second local data.

In an implementation of the present specification, the query instruction includes a query range and a query condition; and the real-time query module is configured to: separately query data within the query range from the at least one piece of first local data and the at least one piece of second local data based on the intermediate index layer information of the at least one piece of first local data and the intermediate index layer information of the at least one piece of second local data, and sort the queried data as to-be-queried data; and querying the to-be-queried data based on the query condition, to determine the data query result.

In an implementation of the present specification, the query range includes a column query range of at least one column group; and when separately querying the data within the query range from the at least one piece of first local data and the at least one piece of second local data based on the query range, the intermediate index layer information of the at least one piece of first local data, and the intermediate index layer information of the at least one piece of second local data, and sorting the queried data as the to-be-queried data, the real-time query module is configured to: for a column group to which each column query range in the query range belongs, determine, based on intermediate index layer information of first local data and intermediate index layer information of second local data in the column group and the column query range of the column group, a first row offset range corresponding to the column query range of the column group; determine a second row offset range based on the first row offset range corresponding to each column query range in the query range; and separately query data within the second row offset range from the at least one piece of first local data and the at least one piece of second local data based on the second row offset range, the intermediate index layer information of the at least one piece of first local data, and the intermediate index layer information of the at least one piece of second local data, and sort the queried data as the to-be-queried data.

In an implementation of the present specification, when determining, based on the intermediate index layer information of the first local data and the intermediate index layer information of the second local data in the column group and the column query range of the column group, the first row offset range corresponding to the column query range of the column group, the real-time query module is configured to: separately query data within a third row offset range within the query range from the first local data and the second local data in the column group based on the intermediate index layer information of the first local data and the intermediate index layer information of the second local data in the column group, and sort the queried data by row offset as a column query result of the column group; and filter the column query result of the column group based on the column query range of the column group, to obtain the first row offset range corresponding to the column query range of the column group.

In an implementation of the present specification, the query range includes a primary key range; and the apparatus further includes a primary key module, configured to: separately query data within the primary key range from first local data and second local data in a primary key column based on intermediate index layer information of the first local data and intermediate index layer information of the second local data in the primary key column, and sort the queried data by row offset as a primary key query result; and determine a second row offset range within the query range based on a row offset of data in the primary key query result.

In an implementation of the present specification, data in the first local data and the second local data is stored in a form of a data block, and each data block stores some data; and when separately querying the data within the query range from the at least one piece of first local data and the at least one piece of second local data based on the intermediate index layer information of the at least one piece of first local data and the intermediate index layer information of the at least one piece of second local data, and sorting the queried data as the to-be-queried data, the real-time query module is configured to: separately query a data block to which the data within the query range belongs from the at least one piece of first local data and the at least one piece of second local data based on the intermediate index layer information of the at least one piece of first local data and the intermediate index layer information of the at least one piece of second local data, and sort the queried data block as to-be-queried data.

In an implementation of the present specification, the data block includes a macro block and a micro block.

In an implementation of the present specification, the target data includes: data generated in the memory based on a data definition language (DDL).

In an implementation of the present specification, different column groups of the target data correspond to same first local data; or different column groups of the target data correspond to different first local data.

The systems, apparatuses, modules, or units described in the above implementations can be specifically implemented by a computer chip or an entity, or can be implemented by a product having a certain function. A typical implementation device is a computer, and a specific form of the computer can be a personal computer, a laptop computer, a cellular phone, a camera phone, a smartphone, a personal digital assistant, a media player, a navigation device, an email receiving/sending device, a game console, a tablet computer, a wearable device, or any combination of several devices in these devices.

In an example configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory can include a non-persistent storage, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic disk storage, a quantum storage, a graphene-based storage medium, another magnetic storage device, or any other non-transmission medium. The computer storage medium can be configured to store information that can be accessed by a computing device. As described in the present specification, the computer-readable medium does not include computer-readable transitory media such as a modulated data signal and a carrier.

It should also be noted that the terms "include", "comprise", or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by "includes a …" does not preclude the existence of additional identical elements in the process, method, product, or device that includes the element.

Particular implementations of the present specification are described above. Other implementations fall within the scope of the appended claims. In some cases, the actions or steps recorded in the claims can be performed in an order different from that in the implementations and the desired results can still be achieved. In addition, the process depicted in the accompanying drawings does not necessarily need a particular order or consecutive order to achieve the desired results. In some implementations, multi-tasking and concurrent processing are feasible or may be advantageous.

The terms used in one or more implementations of the present specification are merely used to describe example implementations, and are not intended to limit the one or more implementations of the present specification. The terms "a" and "the" of singular forms used in one or more implementations of the present specification and the appended claims are also intended to include plural forms, unless otherwise specified in the context clearly. It should be further understood that the term "and/or" used in the present specification indicates and includes any or all possible combinations of one or more associated listed items.

It should be noted that, user information (including but not limited to a device information of a user, personal information of a user, etc.) and data (including but not limited to data used for analysis, stored data, displayed data, etc.) used in the present application are information and data that are authorized by the user or fully authorized by each party, related data needs to be collected, used, and processed by abiding by related laws and regulations and standards of a related country and region, and a corresponding operation entry is provided, so that the user chooses to perform authorization or rejection.

It should be understood that although terms "first", "second", "third", etc. may be used in one or more implementations of the present specification to describe various types of information, the information should not be limited to these terms. These terms are merely used to distinguish between information of the same type. For example, without departing from the scope of one or more implementations of the present specification, first information can also be referred to as second information, and similarly, the second information can also be referred to as the first information. Depending on the context, for example, the word "if" used herein can be explained as "while", "when", or "in response to determining".

The above descriptions are one or more implementations of the present specification, and are not intended to limit the one or more implementations of the present specification. Any modification, equivalent replacement, improvement, etc. made without departing from the spirit and principle of the one or more implementations of the present specification shall fall within the protection scope of the claims of the present application.

1. A data processing method, comprising:
in a process of writing target data in a memory into a disk,
in response to a query instruction for the target data, separately querying data from at least one piece of first local data and at least one piece of second local data based on the query instruction, intermediate index layer information of the at least one piece of first local data, and intermediate index layer information of the at least one piece of second local data,
wherein the first local data includes a first portion of the target data stored in the disk, the second local data includes a second portion of the target data stored in the memory, the target data is in a column-stored form, and each column group of the target data corresponds to a piece of second local data.

2. The data processing method according to claim 1, wherein the query instruction includes a query range and a query condition; and
the separately querying the data from the at least one piece of first local data and the at least one piece of second local data based on the query instruction, the intermediate index layer information of the at least one piece of first local data, and the intermediate index layer information of the at least one piece of second local data includes:
separately querying data within the query range from the at least one piece of first local data and the at least one piece of second local data based on the intermediate index layer information of the at least one piece of first local data and the intermediate index layer information of the at least one piece of second local data;
sorting the data queried as to-be-queried data; and
querying the to-be-queried data based on the query condition, to determine a data query result.

3. The data processing method according to claim 2, wherein the query range includes a column query range of at least one column group; and
the separately querying the data within the query range from the at least one piece of first local data and the at least one piece of second local data based on the query range, the intermediate index layer information of the at least one piece of first local data, and the intermediate index layer information of the at least one piece of second local data includes:
for a column group to which a column query range in the query range belongs, determining, based on intermediate index layer information of first local data and intermediate index layer information of second local data in the column group and the column query range of the column group, a first row offset range corresponding to the column query range of the column group;
determining a second row offset range based on the first row offset range corresponding to the column query range in the query range; and
separately querying data within the second row offset range from the at least one piece of first local data and the at least one piece of second local data based on the second row offset range, the intermediate index layer information of the at least one piece of first local data, and the intermediate index layer information of the at least one piece of second local data.

4. The data processing method according to claim 3, wherein the determining, based on the intermediate index layer information of the first local data and the intermediate index layer information of the second local data in the column group and the column query range of the column group, the first row offset range corresponding to the column query range of the column group includes:
separately querying data within a third row offset range within the query range from the first local data and the second local data in the column group based on the intermediate index layer information of the first local data and the intermediate index layer information of the second local data in the column group； and
sorting the data queried by row offset as a column query result of the column group; and
filtering the column query result of the column group based on the column query range of the column group, to obtain the first row offset range corresponding to the column query range of the column group.

5. The data processing method according to claim 4, wherein the query range includes a primary key range; and
the data processing method further comprises:
separately querying data within the primary key range from first local data and second local data in a primary key column based on intermediate index layer information of the first local data and intermediate index layer information of the second local data in the primary key column；
sorting the data queried by row offset as a primary key query result; and
determining a second row offset range within the query range based on a row offset of data in the primary key query result.

6. The data processing method according to claim 2, wherein data in the first local data and the second local data is stored in a form of a data block, and each data block stores data; and
the separately querying the data within the query range from the at least one piece of first local data and the at least one piece of second local data based on the intermediate index layer information of the at least one piece of first local data and the intermediate index layer information of the at least one piece of second local data includes:
separately querying a data block to which the data within the query range belongs from the at least one piece of first local data and the at least one piece of second local data based on the intermediate index layer information of the at least one piece of first local data and the intermediate index layer information of the at least one piece of second local data; and
sorting the data block queried as to-be-queried data.

7. The data processing method according to claim 6, wherein the data block includes a macro block and a micro block.

8. The data processing method according to claim 1, wherein the target data includes:
data generated in the memory based on a data definition language (DDL).

9. The data processing method according to claim 1, wherein different column groups of the target data correspond to same first local data; or different column groups of the target data correspond to different first local data.

10. An electronic device, comprising:
one or more processors; and
one or more storage devices, individually or collectively, having processor-executable instructions stored thereon, the processor-executable instructions, when executed by the one or more processors, enabling the one or more processors to, individually or collectively, implement actions including:
in a process of writing target data in a memory into a disk,
in response to a query instruction for the target data, separately querying data from at least one piece of first local data and at least one piece of second local data based on the query instruction, intermediate index layer information of the at least one piece of first local data, and intermediate index layer information of the at least one piece of second local data,
wherein the first local data includes a first portion of the target data stored in the disk, the second local data includes a second portion of the target data stored in the memory, the target data is in a column-stored form, and each column group of the target data corresponds to a piece of second local data.

11. The electronic device according to claim 10, wherein the query instruction includes a query range and a query condition; and
the separately querying the data from the at least one piece of first local data and the at least one piece of second local data based on the query instruction, the intermediate index layer information of the at least one piece of first local data, and the intermediate index layer information of the at least one piece of second local data includes:
separately querying data within the query range from the at least one piece of first local data and the at least one piece of second local data based on the intermediate index layer information of the at least one piece of first local data and the intermediate index layer information of the at least one piece of second local data;
sorting the data queried as to-be-queried data; and
querying the to-be-queried data based on the query condition, to determine a data query result.

12. The electronic device according to claim 11, wherein the query range includes a column query range of at least one column group; and
the separately querying the data within the query range from the at least one piece of first local data and the at least one piece of second local data based on the query range, the intermediate index layer information of the at least one piece of first local data, and the intermediate index layer information of the at least one piece of second local data includes:
for a column group to which a column query range in the query range belongs, determining, based on intermediate index layer information of first local data and intermediate index layer information of second local data in the column group and the column query range of the column group, a first row offset range corresponding to the column query range of the column group;
determining a second row offset range based on the first row offset range corresponding to the column query range in the query range; and
separately querying data within the second row offset range from the at least one piece of first local data and the at least one piece of second local data based on the second row offset range, the intermediate index layer information of the at least one piece of first local data, and the intermediate index layer information of the at least one piece of second local data.

13. The electronic device according to claim 12, wherein the determining, based on the intermediate index layer information of the first local data and the intermediate index layer information of the second local data in the column group and the column query range of the column group, the first row offset range corresponding to the column query range of the column group includes:
separately querying data within a third row offset range within the query range from the first local data and the second local data in the column group based on the intermediate index layer information of the first local data and the intermediate index layer information of the second local data in the column group； and
sorting the data queried by row offset as a column query result of the column group; and
filtering the column query result of the column group based on the column query range of the column group, to obtain the first row offset range corresponding to the column query range of the column group.

14. The electronic device according to claim 13, wherein the query range includes a primary key range; and
the actions further include:
separately querying data within the primary key range from first local data and second local data in a primary key column based on intermediate index layer information of the first local data and intermediate index layer information of the second local data in the primary key column；
sorting the data queried by row offset as a primary key query result; and
determining a second row offset range within the query range based on a row offset of data in the primary key query result.

15. The electronic device according to claim 11, wherein data in the first local data and the second local data is stored in a form of a data block, and each data block stores data; and
the separately querying the data within the query range from the at least one piece of first local data and the at least one piece of second local data based on the intermediate index layer information of the at least one piece of first local data and the intermediate index layer information of the at least one piece of second local data includes:
separately querying a data block to which the data within the query range belongs from the at least one piece of first local data and the at least one piece of second local data based on the intermediate index layer information of the at least one piece of first local data and the intermediate index layer information of the at least one piece of second local data; and
sorting the data block queried as to-be-queried data.

16. The electronic device according to claim 15, wherein the data block includes a macro block and a micro block.

17. A computer-readable storage medium, the computer-readable storage medium having computer instructions stored thereon, the computer instructions, when executed by one or more processors, enabling the one or more processors to, individually or collectively, implement actions including:
in a process of writing target data in a memory into a disk,
in response to a query instruction for the target data, separately querying data from at least one piece of first local data and at least one piece of second local data based on the query instruction, intermediate index layer information of the at least one piece of first local data, and intermediate index layer information of the at least one piece of second local data,
wherein the first local data includes a first portion of the target data stored in the disk, the second local data includes a second portion of the target data stored in the memory, the target data is in a column-stored form, and each column group of the target data corresponds to a piece of second local data.

18. The storage medium according to claim 17, wherein the query instruction includes a query range and a query condition; and
the separately querying the data from the at least one piece of first local data and the at least one piece of second local data based on the query instruction, the intermediate index layer information of the at least one piece of first local data, and the intermediate index layer information of the at least one piece of second local data includes:
separately querying data within the query range from the at least one piece of first local data and the at least one piece of second local data based on the intermediate index layer information of the at least one piece of first local data and the intermediate index layer information of the at least one piece of second local data;
sorting the data queried as to-be-queried data; and
querying the to-be-queried data based on the query condition, to determine a data query result.

19. The storage medium according to claim 18, wherein the query range includes a column query range of at least one column group; and
the separately querying the data within the query range from the at least one piece of first local data and the at least one piece of second local data based on the query range, the intermediate index layer information of the at least one piece of first local data, and the intermediate index layer information of the at least one piece of second local data includes:
for a column group to which a column query range in the query range belongs, determining, based on intermediate index layer information of first local data and intermediate index layer information of second local data in the column group and the column query range of the column group, a first row offset range corresponding to the column query range of the column group;
determining a second row offset range based on the first row offset range corresponding to the column query range in the query range; and
separately querying data within the second row offset range from the at least one piece of first local data and the at least one piece of second local data based on the second row offset range, the intermediate index layer information of the at least one piece of first local data, and the intermediate index layer information of the at least one piece of second local data.

20. The storage medium according to claim 19, wherein the determining, based on the intermediate index layer information of the first local data and the intermediate index layer information of the second local data in the column group and the column query range of the column group, the first row offset range corresponding to the column query range of the column group includes:
separately querying data within a third row offset range within the query range from the first local data and the second local data in the column group based on the intermediate index layer information of the first local data and the intermediate index layer information of the second local data in the column group； and
sorting the data queried by row offset as a column query result of the column group; and
filtering the column query result of the column group based on the column query range of the column group, to obtain the first row offset range corresponding to the column query range of the column group.
